(19) United States
(12) Patent Application Publication
(10) Pub. No.: US 2005/0129105 A1
(43) Pub. Date: Jun. 16, 2005

(54) Determination of the adaption coefficient for adaptive equalizers in communication systems based on the estimated signal-to-noise ratio and the mobile speed

(76) Inventor: Aris Papasakellariou, Dallas, TX (US)

Correspondence Address: TEXAS INSTRUMENTS INCORPORATED, P O BOX 655474, M/S 3999, DALLAS, TX, 75265, US

(21) Appl. No.: 10/734,344

(22) Filed: Dec. 11, 2003

(51) Int. Cl. H04B 1/69

(52) U.S. Cl. 375/232; 375/147

(57) ABSTRACT

Adaptive chip-based equalizers are considered for the mobile receiver of CDMA communication systems as a low complexity solution that is capable of removing multipath interference and improving performance relative to the conventional Rake receiver. The performance of adaptive equalizers is critically impacted by the mobile's speed which is directly related to the update size of the equalizer's weights and the associated adaptation coefficient value. This has been recognized in the art and the selection of the adaptation coefficient value is based on the mobile speed. The disclosed invention proposes a novel method for selecting the adaptation coefficient that is based on the signal-to-noise ratio (SNR), as measured at the receiver, in addition to the mobile speed. In that manner, the adaptation coefficient becomes a function of two parameters. The motivation for making the adaptation coefficient dependent on the SNR stems from the fact that for large SNR values, equalization is accurate and faster adaptation can be supported while the opposite is true for low SNR values. Exploiting this fact allows the equalizer to improve channel tracking and offer better performance. The complexity of a receiver employing an adaptive equalizer and the disclosed invention is not increased since the receiver already measures the SNR in support of other functions.

### TECHNICAL FIELD

This invention relates in general to communication systems, and more particularly to a method and apparatus for determining the adaptation coefficient of adaptive equalizers used for channel equalization in spread spectrum communication systems.

### BACKGROUND

Code Division Multiple Access (CDMA) has been extensively used in such areas as cellular and satellite communications. CDMA signals increase the spectrum required for the transmission of a particular data rate, by modulating each information symbol with a spread spectrum code having a rate larger than the data rate. In CDMA systems, the same spreading code is used for each information symbol. Typically, the spreading code is comprised of several tens or a few hundred elements, called chips. To decrease the correlation among spreading codes assigned to different system users, and thereby reduce the interference among the different users, the data stream after having been spread is typically scrambled with a pseudonoise (PN) code that is generated serially and cyclically and has a larger period than the spreading code. Examples of such CDMA signal spreading schemes are the schemes used by the various evolutions of 3GPP (Third Generation Partnership Project) and 3GPP2 communication standards.

In the forward link of CDMA cellular communication systems, i.e. the communication link from base stations to mobile terminals (also referred to as user equipment (UE) or devices); the wireless channel may introduce multipath propagation. Even if the signals transmitted by the base station are spread using orthogonal codes (e.g., Walsh codes), the multipath propagation may destroy the orthogonality and produce multiple-access interference (MAI).

Typically, the forward link also includes a common pilot channel (CPICH) that carries known data and can be decoded by all mobiles. The CPICH is intended to provide channel information in order to enable the UE receiver to identify received signal paths, estimate the channel, and perform tracking functions such as time and frequency tracking. Examples of CDMA communication systems including a CPICH are the evolutions of 3GPP and 3GPP2.

If the forward link does not employ transmit diversity, then an identical channel is experienced by the desired signal and the remaining same-cell interfering signals. For systems employing orthogonal spreading codes, such as the evolutions of 3GPP and 3GPP2, chip equalization can restore orthogonality even in the presence of a scrambling code with period much longer than the one of the orthogonal code (long scrambling code).

Several channel equalization methods have been proposed in the literature, including a least-mean-squares (LMS) algorithm approach [1] (Visotsky, et al, U.S. Pat. No. 6,175,588, Jan. 16, 2001), a Prefilter Rake receiver approach [2] (Heikkilae and Komulainen, WO0054427, 2000-09-14), a Griffiths equalizer approach [3] (Heikkila, “A Novel Blind Adaptive Algorithm for Channel Equalization in WCDMA Downlink”, pages A-41-A-45, Personal, Indoor and Mobile Radio Communications (PIMRC) 2001), and the conventional least-minimum-mean-squared-error (LMMSE) algorithm. All aforementioned equalizers, with the exception of LMMSE, are adaptive and have a similar structure.

The LMMSE has the potential to provide the best performance at the expense of very high computational complexity. Its operation requires channel estimates for all paths and the inversion of the associated channel response covariance matrix at the rate of channel estimation updates. This matrix may not always be invertible, particularly in independently fading multipath channels. A consequence is that the channel response covariance matrix needs to span a much larger duration than the one defined by the multipath delay spread. Since the multipath delay spread may be in the order of tens of chip periods, the channel response covariance matrix dimension may well exceed 100 in order to ensure it is invertible with a large enough probability. Moreover, the LMMSE performance degrades significantly in the presence of imperfections such as unresolved paths and small timing errors. The complexity and sensitivity of the LMMSE to realistic imperfections severely diminish its usefulness as a channel equalizer in CDMA communication systems.

In response to the above limitations and implementation complexity of the LMMSE, adaptive equalizers with linear complexity have been the focus of extensive study. The performance of such equalizers depends critically, among other factors, on the proper selection of the adaptation coefficient. This coefficient directly affects the size of the update of the equalizer weights. In slowly varying channels, such as the ones encountered in Pedestrian applications (i.e., movement of a mobile terminal by a user of the mobile terminal wherein the movement is not caused by a motorized vehicle—one example being movement of the mobile terminal caused by the user of the mobile terminal walking from one physical location to another), the update of the equalizer weights can be slow thereby allowing small adaptation coefficient values and efficient channel tracking. In moderate to fast varying channels, such as the ones encountered in Vehicular applications (i.e., movement of a mobile terminal by a user of the mobile terminal wherein the movement is caused by a motorized vehicle—one example being movement of the mobile terminal caused by the user of the mobile terminal riding in a moving automobile), the update of the equalizer weights needs to be faster in order to maintain channel tracking. Ideally, for very large values of the received signal-to-noise ratio (SNR), the increase in the adaptation coefficient should be proportional to the increase in the channel variation. In practice however, the update size of the equalizer weights has to be smaller because, for realistic SNR values, the update may be inaccurate and large update values can lead to an unstable equalizer implementation and complete loss of channel tracking. This practical limitation in the equalizer update size contributes to imperfect equalization and performance loss especially for moderate to fast varying channels. The conventional approach in prior art has been to define the adaptation coefficient as a function of the UE speed so that long term performance is optimized for the particular UE speed and equalizer stability is ensured.

One method employed to determine the UE speed utilizes estimation of the Doppler shift associated with the spectrum of the received signal. The Doppler shift is directly related to the signal fading and is caused by the movement of objects the signals encounters between and including the transmitter and the receiver. The benefits of using Doppler shift to determine the UE speed, however, do not overcome the previously discussed problems associated with the complexity and sensitivity of the LMMSE to realistic imperfections.

### SUMMARY OF THE INVENTION

The present invention presents a method and apparatus for determining the adaptation coefficient of an adaptive equalizer as a function of the instantaneous received signal-to-noise ratio (SNR) in addition to the estimated UE speed. In that manner the adaptation coefficient is a function of two parameters, received SNR and UE speed, and can change during the reception data frames even though the UE speed may remain unchanged during that time period. The prior art considered the adaptation coefficient only as a function of the UE speed. Estimation of the UE speed can be provided through estimation of the Doppler shift for the received signal. The proposed method exploits the SNR estimation already performed at the UE receiver to serve other receiver purposes and does not introduce any additional complexity relative to a receiver implementing an adaptive equalizer without using the method of the disclosed invention. There are several, well known in the art methods to perform SNR estimation.

The motivation for the disclosed invention relies on the fact that the quality of the equalizer weight update is directly related to the instantaneous received SNR. The updates can therefore be made faster when the received SNR is large and smaller when it is low. Naturally, the channel variation dictated by the UE speed at a specified frequency of communication is another parameter taken into consideration when determining the adaptation coefficient and the equalizer weight update size.

The proposed method applies to any type of adaptive equalizer utilizing an adaptation coefficient to determine the weight updates including the NLMS, Prefilter Rake, and Griffiths equalizers.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 shows a block diagram of a CDMA receiver section including a CPICH-based normalized LMS (NLMS) equalizer.

FIG. 2 shows a chart comparing Frame Error Rate (FER) as a function of geometry for 10 DPDCH for different equalizers.

FIG. 3 shows a chart comparing Frame Error Rate (FER) as a function of geometry for 6 DPDCH for different equalizers.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

The following description of the preferred embodiment applies to the mobile receiver (or user equipment UE) of a CDMA communication system. This description considers the forward link of a CDMA system employing the transmission of a Common Pilot Channel (CPICH) and of multiple dedicated physical data channels (DPDCH) to the same UE that are distinguished by different orthogonal codes. Examples of such CDMA systems include all evolutions of 3GPP and 3GPP2 systems.

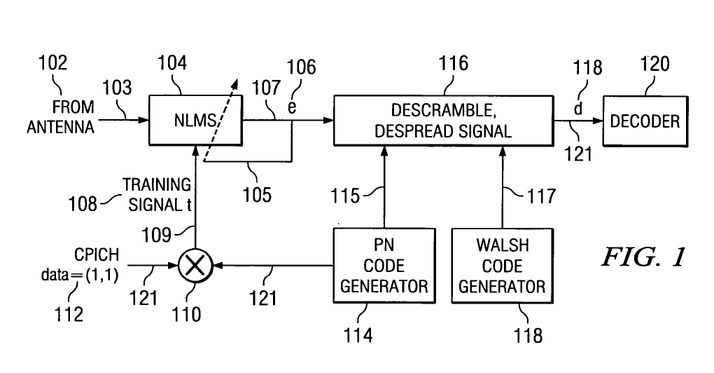

A block diagram of an NLMS CPICH-based chip equalizer is shown in FIG. 1. A received filtered signal 102 is received at one input of CPICH-based NLMS equalizer 104 via signal line 103. Equalizer 104 outputs an equalized output signal e 106 onto signal line 107 which couples an output of equalizer 104 to an input of a circuit 116 and to an input of equalizer 104. Equalized output signal 106 is fed back to equalizer 104, via signal line 105, in order to be compared with a training signal t 108 that is received at another input of equalizer 104 via signal line 109. Equalized output signal 106 is further fed to the input of circuit 116. Circuit 116 descrambles and despreads equalized output signal 106 with a complex scrambling code, via signal line 115 and a Walsh code via line 117, that circuit 116 receives from a PN code generator 114 and Walsh code generator 118, respectively. A multiplier 110 multiplies a complex scrambling code received from PN code generator 114, received via signal line 119, with CPICH data 112, received via signal line 121. Signal line 109 couples an output of multiplier 110 to an input of equalizer 104. Multiplier 110 outputs training signal t 108 to equalizer 104 via signal line 109. Circuit 116 outputs a decision statistic d 118 via signal line 121 to an input of decoder 120 for further use by the decoder. Notice that the Walsh code assigned to CPICH data signal 112 is assumed to comprise of all ones (numeric) and therefore multiplication with the Walsh code to obtain the CPICH training signal is not needed.

The NLMS of a preferred embodiment of the present invention uses the CPICH as the training signal to perform adaptive equalization. The parameters and operation of the NLMS equalizer circuit of FIG. 1 are given as follows:

NLMS Parameters

μ—adaptation constant
a—positive constant (default 0)
D—delay for the desired signal
   Data
\overline{r}(n)—received signal in the filter at time n
w(n)—filter tap coefficients at time n
x(n)=W^{H}(n)\overline{r}(n)—equalizer output at time n
d(n)—desired response, (CPICH chip at time n for NLMS 204)
w(0)=0
Initialization
Computation

$$\begin{matrix}output signal x ( n ) = {w}^{H} ( n ) \overline{r} ( n ) \\ w ( n + 1 ) = w ( n ) + \frac{μ}{a + {‖ \overline{r} ( n ) ‖}^{2}} \overline{r} ( n ) e * ( n ) \\ error signal e ( n ) = d ( n - D ) - x ( n )\end{matrix}$$

The performance of the NLMS at various speeds and geometries (defined as the ratio of intracell to intercell interference) is now considered for various values of the adaptation coefficient. This performance evaluation will clearly show the dependence of the adaptation coefficient providing the best performance on both the received SNR (related to the geometry) and the UE speed.

The evaluation setup considers the 3GPP Release 5 (also known as HSDPA) system framework and the base station to UE link (forward link). The base station transmits to the UE a variable number of HSDPA signals using a variable number of UE dedicated Walsh codes (multicode transmission), QPSK or 16-QAM modulation, and variable coding rate in a scheme known as adaptive modulation and coding (AMC). The modulation and coding scheme selection (MCS) is determined by the SNR or another channel quality indicator (CQI). The channel quality is typically associated with the SNR. For low SNR, a specified frame-error-rate (FER) can only be supported with a low MCS involving the transmission of only a few multicodes, QPSK modulation, and low coding rate. Conversely, for high SNR, the transmission link is good enough to support several multicodes, 16-QAM modulation, and high coding rates. A typical target FER is between 5% and 20%.

The NLMS equalizer length was 16 taps, chip spaced. The adaptation coefficient was varied as a multiple of a nominal value selected to be 0.008. Multiples of 0.5, 1, 1.5, 2, 3, and 4 of the nominal value were considered and this range always covered the optimum adaptation coefficient at all SNR values and UE speeds. Moreover, for all geometries required to achieve 10% FER for the HSDPA transmission, the CPICH power was kept constant at 10% of the total transmit power. The performance of the CPICH-based NLMS is therefore affected only by the change in SNR, through the change in the geometry.

The FER performance is considered for QPSK and 16-QAM modulations and for turbo coding with rate equal to ½. The channel model used for performance evaluation was the ITU Vehicular A model. The UE speed was 90 Km/h for the QPSK modulation setup and 30 K/n/h for the 16-QAM one. The exemplary cases of 1 and 6 HSDPA signals (1 and 6 UE dedicated codes) were considered for QPSK and additional 3GPP Release 1999 voice interference signals were transmitted in both cases with combined power equal to 40% of the total transmit power. The exemplary cases of 1 and 4 HSDPA signals were considered for 16-QAM. Additional 3GPP Release 1999 voice interference signals were also transmitted with combined power equal to 10% of the total transmit power for the case of 1 HSDPA signal and 40% of the total transmit power for the case of 4 HSDPA signals.

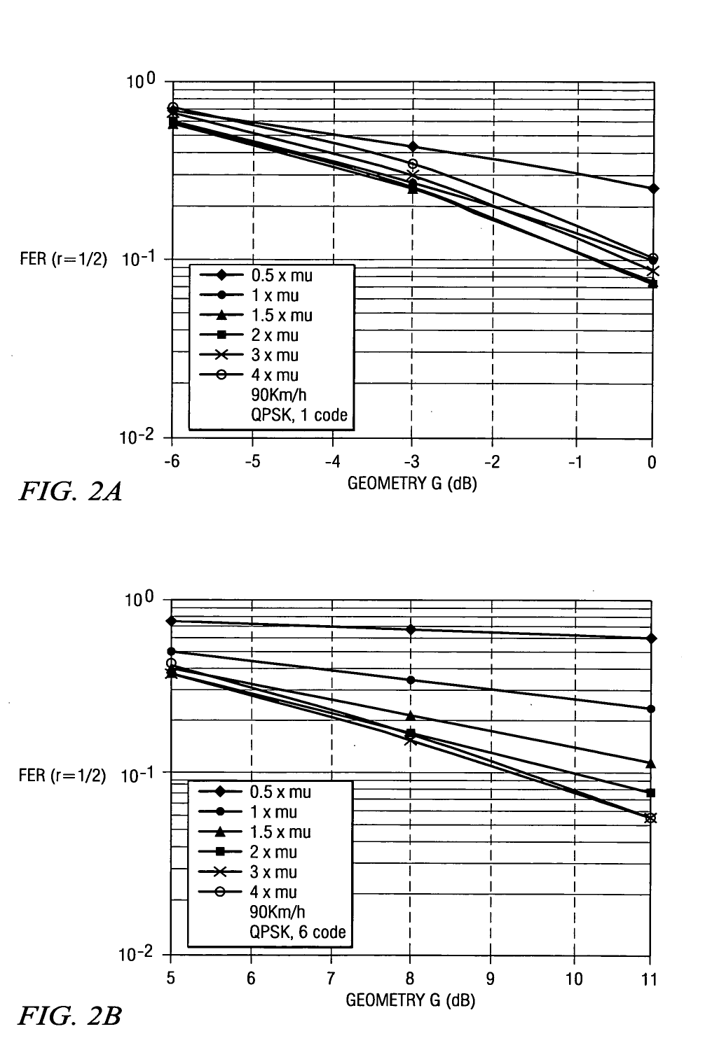

FIG. 2 illustrates the FER performance for QPSK modulation. More particularly, FIG. 2 illustrates NLMS Equalizer Frame Error Rate with QPSK Modulation at Different Geometries for 1 and 6 HSDPA codes, respectively. For 1 HSDPA signal, at 10% FER, the optimum scaling factor for the nominal adaptation coefficient is between 1.5 and 2.0. For 6 HSDPA signals, much larger geometries are required to achieve FERs in the range of interest and the optimum scaling factor is now between 3.0 and 4.0. Therefore, having a fixed adaptation coefficient that depends only on the UE speed and does not depend on the geometry will lead to performance losses which in the present example, under the assumption that the scaling factor is always 3.0, are about 0.4 dB at 10% FER. This loss becomes larger as the difference in geometries increase.

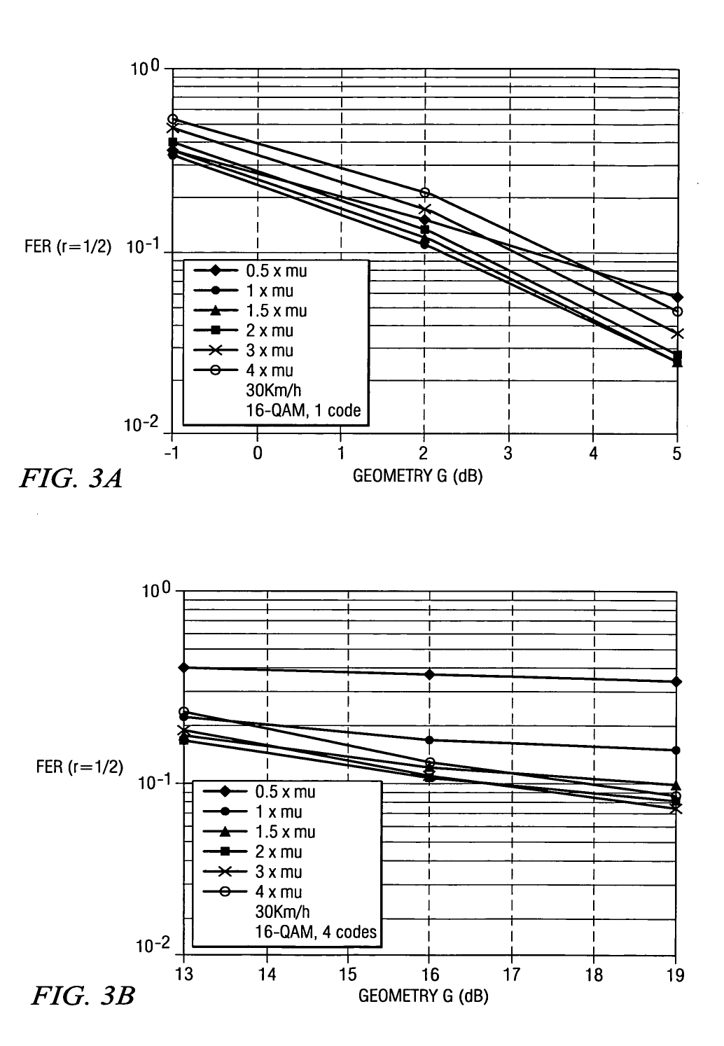

FIG. 3 illustrates the FER performance for 16-QAM modulation. More particularly, FIG. 3 illustrates NLMS Equalizer Frame Error Rate with 16-QAM Modulation at Different Geometries for 1 and 4 HSDPA codes, respectively. For 1 HSDPA signal, the optimum scaling factor of the nominal adaptation coefficient is 1.0 with the scaling factor of 1.5 resulting in only 0.1 dB relative performance loss. For 4 HSDPA signals, much larger geometries are required to achieve the goal of about 10% FER and the optimum scaling factor is now between 2.0 and 3.0. A scaling factor of 1.0 gives unacceptable performance and significant dB losses while a scaling factor of 1.5 results to a loss of at least 1.0 dB for the smaller FER values.

In general, the performance of larger scaling factors relative to smaller ones improves as the geometry, and hence the average SNR, increase. This can be observed in both the results of the different scaling factors for the same setup and between different setups. The exemplary results considered only different geometries specifying different average SNRs. The performance gains from having the adaptation coefficient depend on the SNR will be even larger if the instantaneous, short-term, SNR is considered since the adaptation will have better granularity and be tailored to the instantaneous channel conditions instead to the average ones.

The previous performance results demonstrate the need to adjust the adaptation coefficient value to the SNR. Notice that larger geometries only correspond to larger average SNR while the instantaneous SNR can be larger but also smaller between different geometries due to fading. The gains from tailoring the adaptation coefficient to the instantaneous SNR, in addition to the UE speed, will be larger than the ones demonstrated in FIG. 2 and FIG. 3 where only the average SNR was considered as specified by the particular geometry.

The present invention has been described with reference to a preferred embodiment. However, those skilled in the art having read this disclosure will recognize that changes and modifications may be made to the preferred embodiment without departing from the scope of the present invention. These and other changes or modifications are intended to be included within the scope of the present invention.

1. In a mobile communication device receiving a spread spectrum signal which includes a common pilot channel (CPICH) signal and at least one dedicated physical data channel (DPDCH) signal, a method for performing channel equalization at a receiver, comprising the steps of:
(a) measuring the speed of said mobile communication device;
(b) measuring a channel quality indicator;
(c) using said measurements of speed and channel quality indicator to determine a value for the adaptation coefficient of an adaptive equalizer;
(d) using said adaptation coefficient and said adaptive equalizer to perform equalization of said at least one DPDCH signal.

2. A method as defined in claim 1, wherein said channel quality indicator in step (b) is signal-to-noise ratio of said CPICH signal.

3. A method as defined in claim 1, wherein said channel quality indicator in step (b) is signal-to-noise ratio of said at least one DPDCH signal.

4. A method as defined in claim 1, wherein said adaptive equalizer in step (c) and step (d) is the NLMS adaptive equalizer.

5. A method as defined in claim 1, wherein said adaptive equalizer in step (c) and step (d) is the Griffiths adaptive equalizer.

6. A method as defined in claim 1, wherein said adaptive equalizer in step (c) and step (d) is the Prefilter Rake adaptive equalizer.

7. A method as defined in claim 1, wherein said measuring speed of said communication device includes performing Doppler shift estimation.

8. A communication apparatus, comprising:
means for measuring the speed of physical movement of said apparatus;
means for measuring a channel quality indicator;
means for using said measurements of speed and channel quality indicator to determine a value for the adaptation coefficient of an adaptive equalizer; and
means for using said adaptation coefficient and said adaptive equalizer to perform equalization of said at least one dedicated physical data channel (DPDCH) signal.

9. The apparatus of claim 8, wherein said means for measuring a channel quality indicator uses signal-to-noise ratio of a CPICH signal to determine channel quality.

10. The apparatus of claim 8, wherein said means for measuring a channel quality indicator uses signal-to-noise ratio of said at least one DPDCH signal.

11. The apparatus of claim 8, wherein said adaptive equalizer in said means for using said measurements of speed and channel quality indicator to determine a value for the adaptation coefficient of an adaptive equalizer is an NLMS adaptive equalizer.

12. The apparatus of claim 8, wherein said adaptive equalizer in said means for using said measurements of speed and channel quality indicator to determine a value for the adaptation coefficient of an adaptive equalizer is a Griffiths adaptive equalizer.

13. The apparatus of claim 8, wherein said adaptive equalizer in said means for using said measurements of speed and channel quality indicator to determine a value for the adaptation coefficient of an adaptive equalizer is a Prefilter Rake adaptive equalizer.

14. The apparatus of claim 8, wherein said measuring speed of said apparatus includes performing Doppler shift estimation.
